(19) United States
(12) Patent Application Publication
(10) Pub. No.: US 2009/0060235 A1
(43) Pub. Date: Mar. 5, 2009

(54) SOUND PROCESSING APPARATUS AND SOUND PROCESSING METHOD THEREOF

(75) Inventors: Won-hee WOO, Seongnam-si (KR); Pil-sung Koh, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/047,693

(22) Filed: Mar. 13, 2008

(30) Foreign Application Priority Data
Aug. 31, 2007 (KR) 2007-88316

(51) Int. Cl. H04R 5/02

(52) U.S. Cl. 381/303

(57) ABSTRACT

A sound processing apparatus includes a sound processor to process sound, a plurality of image generators to photograph an object and generate an image, respectively, and a controller to recognize a position of the object with the plurality of images generated by the plurality of image generators, and control the sound processor to adjust a property of the sound corresponding to the position of the object.

### CROSS-REFERENCE TO RELATED APPLICATIONS

This application claims priority under 35 U.S.C. § 119(a) from Korean Patent Application No. 10-2007-0088316, filed on Aug. 31, 2007, in the Korean Intellectual Property Office, the disclosure of which is incorporated herein in its entirety by reference.

### BACKGROUND OF THE INVENTION

1. Field of the Invention

The present general inventive concept relates to a sound processing apparatus and a sound processing method thereof, and more particularly, to a sound processing apparatus which adjusts properties of sound and provides a sound effect, and a sound processing method thereof.

2. Description of the Related Art

A conventional sound processing apparatus, such as an audio device or a TV, may adjust properties of sound. The properties of sound may include frequency, waveform, delay time, volume according to a frequency band, etc. The sound processing apparatus may adjust properties of sound according to a user's input. For example, the user may adjust the properties of sound by controlling an equalizer or selecting a sound effect in the sound processing apparatus.

The user may experience optimal sound within an area known as a “sweet spot.” The sweet spot is a location where the user can hear the sound in the manner intended by a designer of the sound processing apparatus.

FIG. 1 illustrates a sweet spot in the conventional sound processing apparatus. As illustrated therein, a sweet spot 20 is a location in front of a left speaker 11 and a right speaker 12 and is at the same distance from the speakers 11 and 12. In this case, the user may experience optimal sound within the sweet spot 20.

However, in the conventional sound processing apparatus, physical factors such as arrangement of speakers 11 and 12 are mainly considered in determining the sweet spot 20. Thus, the sweet spot 20 is dependent on such factors of physical speaker location. If the user moves out of the sweet spot 20, sound quality may be decreased or the sound may be distorted.

To automatically adjust the sweet spot 20 according to the user's position, the sound processing apparatus should recognize the user's position with relation to the speakers, which is not easy.

### SUMMARY OF THE INVENTION

The present general inventive concept provides a sound processing apparatus which provides optimal sound according to a user's position, and a sound processing method thereof.

The present general inventive concept also provides a sound processing apparatus which recognizes a user's position more accurately with a camera, and a sound processing method thereof.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept are achieved by providing a sound processing apparatus, comprising a sound processor to process sound, a plurality of image generators to photograph an object and generate an image, respectively, and a controller to recognize a position of the object with the plurality of images generated by the plurality of image generators, and control the sound processor to adjust a property of the sound corresponding to the position of the object.

The property of the sound may comprise at least one of frequency, waveform, delay time and volume according to frequency band.

The plurality of image generators may photograph the object at predetermined time intervals.

The sound processing apparatus may further comprise a motion detector to detect a motion of the object, wherein the controller controls the plurality of image generators to photograph the object and generate images if the motion of the object is detected.

The sound processing apparatus may further comprise a sound output unit to output sound processed by the sound processor.

The foregoing and/or other aspects and utilities of the present general inventive concept can also be achieved by providing a sound processing method, comprising photographing an object and generating a plurality of images, recognizing a position of the object with the plurality of generated images, and adjusting a property of the sound corresponding to the position of the object.

The property of the sound may comprise at least one of frequency, waveform, delay time and volume according to a frequency band.

The generating the plurality of images may comprise photographing the object at predetermined time intervals.

The generating the plurality of images may comprise photographing the object and generating the images if the motion of the object is detected.

The sound processing method may further comprise adjusting the property of the sound corresponding to a position of the object and outputting the processed sound.

The foregoing and/or other aspects and utilities of the present general inventive concept can also be achieved by providing a sound processing apparatus to process and output sound, the sound processing apparatus comprising a sensor to sense a location of an object by generating a plurality of images of the object and by comparing the plurality of generated images and a controller to adjust a property of the sound corresponding to the sensed location of the object.

The sensor may comprise a plurality of image generators to generate the plurality of images of the object by photographing the object.

The controller may compare locations of the object in each of the plurality of images to determine whether a property of the sound should be adjusted.

The sensor may further comprise a motion detector to detect a new location of the object if the object moves, and to send information regarding the object's new location to the controller to adjust a property of the sound corresponding to the new location of the object.

The motion detector may include an infrared sensor to sense objects which are above a certain temperature.

The sensor may comprise a plurality of heat-signature reading devices to each detect a heat signature of the object and generate the images based on the heat signatures.

The foregoing and/or other aspects and utilities of the present general inventive concept can also be achieved by providing a sound processing method, comprising generating a plurality of images of an object, comparing the plurality of generated images in order to determine a location of the object, and adjusting a property of sound corresponding to the determined location of the object and adjusting a property of sound corresponding to the location of the object by comparing the plurality of generated images.

The sound processing method may further comprise photographing the object from multiple angles, and generating corresponding images to denote a location of the object relative to the sensor.

The sound processing method may further comprise detecting a new location of the object if the object moves, and sending information regarding the object's new location to a controller to adjust a property of the sound corresponding to the new location of the object.

The sound processing method may further comprise detecting a heat signature of the object from multiple angles, and generating the images based on the heat signatures.

### BRIEF DESCRIPTION OF THE DRAWINGS

The above and/or other aspects and utilities of the present general inventive concept will become apparent and more readily appreciated from the following description of the embodiments, taken in conjunction with the accompanying drawings of which:

FIG. 1 illustrates a sweet spot in a conventional sound processing apparatus;

FIG. 2 is a block diagram of a sound processing apparatus according to an exemplary embodiment of the present general inventive concept;

FIG. 3 illustrates an image generator of the sound processing apparatus according to an exemplary embodiment of the present general inventive concept;

FIG. 4 is a block diagram of a sound processing apparatus according to another exemplary embodiment of the present general inventive concept; and

FIG. 5 is a flowchart to describe a sound processing method according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

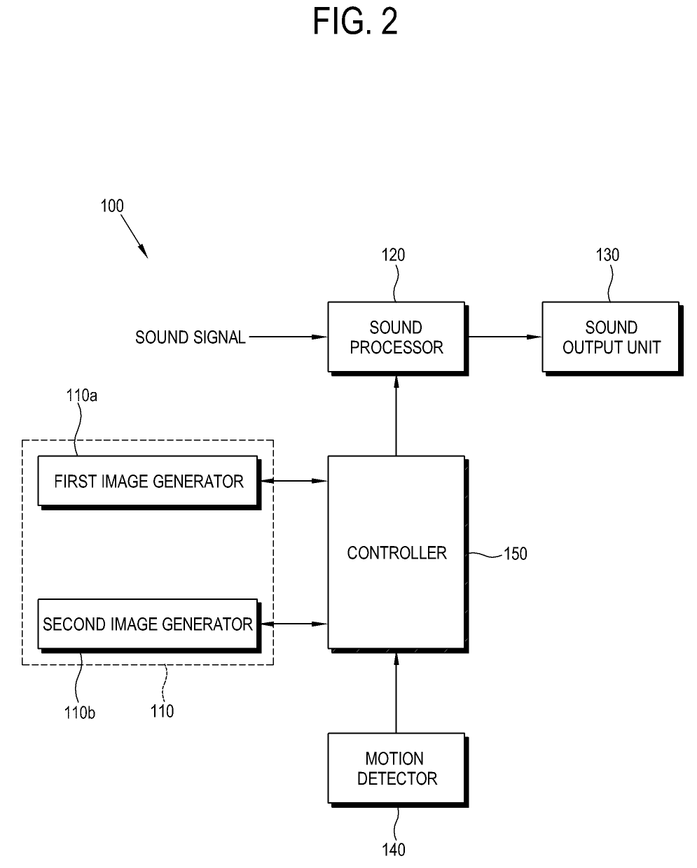

FIG. 2 is a block diagram illustrating a sound processing apparatus 100 according to an exemplary embodiment of the present general inventive concept. The sound processing apparatus 100 according to the exemplary embodiment of FIG. 2 adjusts properties of sound depending on a user's position and optimizes a sweet spot corresponding to the user. Here, the sound processing apparatus 100 may recognize the user's position by photographing an object with a plurality of image generators, such as cameras. Also, the sound processing apparatus 100 may include a variety of sound-producing devices, such as an audio device, a TV, etc.

As illustrated in FIG. 2 therein, the sound processing apparatus 100 may include a plurality of image generators 110, a sound processor 120, a sound output unit 130, a motion detector 140 and a controller 150.

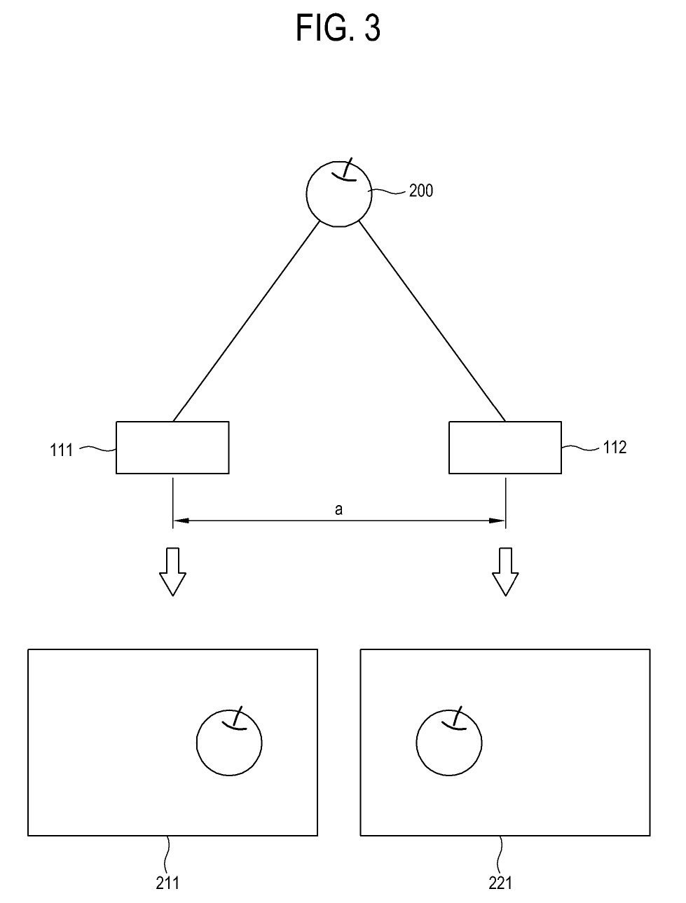

Each of the plurality of image generators 110 photographs an object and generates images, respectively. The plurality of image generators 110 may include a first image generator 111 and a second image generator 112. As illustrated in FIG. 3, the plurality of image generators 110 may further include a first image generator 110a which may comprise a first camera 111 and a second image generator 110b which may comprise a second camera 112. The first and second cameras 111 and 112 simultaneously photograph a single object 200 and generate a first image 211 and a second image 221, respectively. According to another exemplary embodiment, the first and second cameras 111 and 112 may photograph the object 200 at a different timing. According to another exemplary embodiment, the plurality of image generators 110 can include a plurality of sensors which can generate images of the object 200 using devices that read heat signatures of objects, including devices such as infrared sensors, motion detectors, etc.

The first and second cameras 111 and 112 are disposed from each other at a distance a. Thus, the first and second cameras 111 and 112 may have different information on the position of the object 200, as can be seen when comparing positions of a photographed image of the single object 200 in each of the first and second images 211 and 221.

Referring to FIGS. 2 and 3, the plurality of image generators 110 may photograph the object 200 at predetermined time intervals according to a control of the controller 150 (to be described later). For example, the plurality of image generators 110 may photograph the object 200 at five-second intervals to compensate for any incidental or potential movement of the object 200.

The sound processor 120 may process sound to provide a set sound effect. For example, the sound effect may include 3D surround effect, low-sound enhancing, etc. The sound which is output by the sound output unit 130 has an inherent property. The property of the sound may include at least one of frequency, waveform, delay time, volume according to a frequency band and left/right balance. The sound processor 120 adjusts the property of the sound output by the sound output unit 130 according to a control of the controller 150 (to be described later).

The sound output unit 130 outputs sound processed by the sound processor 120. For example, the sound output unit 130 may include a plurality of speakers.

The motion detector 140 detects a motion of the object 200. For example, the motion detector 140 may include an infrared sensor to detect the motion of the object 200, and then may transmit the detection result to the controller 150. The infrared sensor may sense the object 200 by a difference in heat between the environment and the object 200, and may include any infrared sensors well-known in the art, such as pyroelectric sensors, etc. The detection result may include information regarding various positions of the object 200 with respect to the motion detector 140 at various times.

The sound effect is determined by the property of the sound. If the property of the sound is changed, the sound effect is changed, accordingly. A location of the sweet spot is determined not only by physical factors such as an arrangement of the speakers, but also by the property of the sound, such as the sound effect. If the property of sound is adjusted, the location of the sweet spot of the output sound may be changed as well. The controller 150 determines the property of sound so that the location of the sweet spot of the sound output by the sound output unit 130 corresponds to the position of the object 200. The controller 150 also controls the sound processor 120 to adjust the property of the sound according to the determined property.

The controller 150 recognizes the position of the object 200 by analyzing the plurality of images generated by the plurality of image generators 110, and compares the recognized position of the object 200 with the location of the sweet spot of the sound output by the sound output unit 130, to thereby determine whether the location of the sweet spot corresponds to the position of the object 200. If the recognized position of the object 200 is out of the range of the sweet spot of the output sound, the controller 150 adjusts the property of the sound and moves the sweet spot to the position of the object 200. Accordingly, the object 200 is disposed within the sweet spot. If the object moves, the controller 150 may determine whether the position of the object 200 is out of the range of the newly moved sweet spot of the sound. For example, the controller 150 may determine whether the object 200 moves by using the motion detector 140.

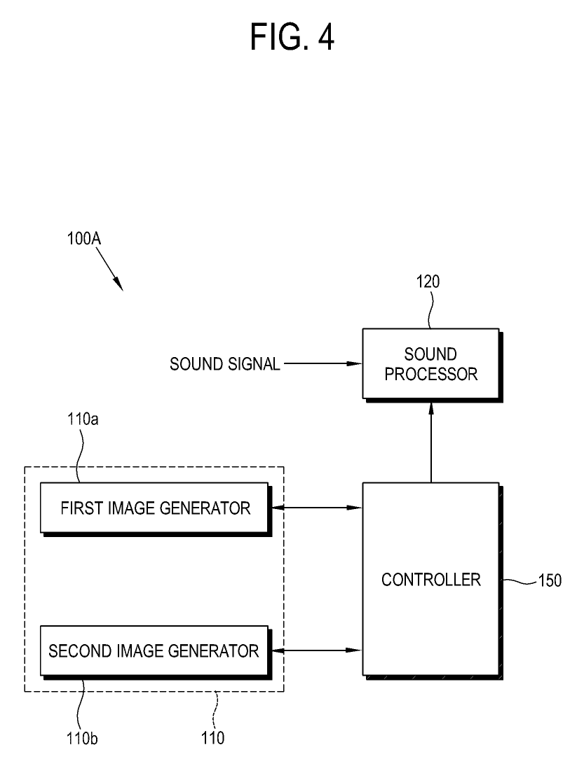

FIG. 4 is a block diagram of a sound processing apparatus 100A according to another exemplary embodiment of the present general inventive concept. As illustrated in FIG. 4, the sound processing apparatus 100A may include a plurality of image generators 110, a sound processor 120 and a controller 150. Repetitive or similar descriptions will be avoided as necessary.

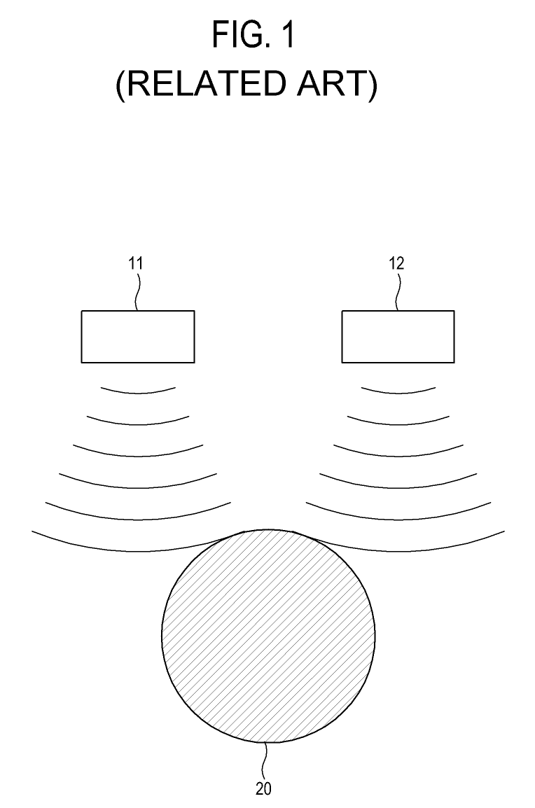

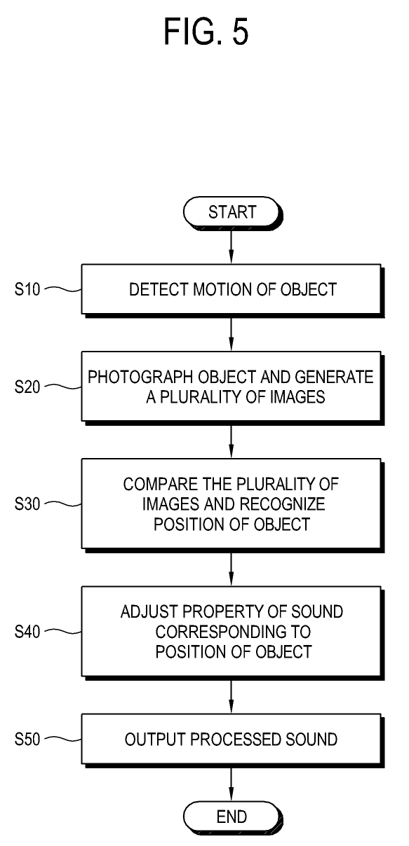

Hereinafter, a sound processing method according to the exemplary embodiment of the present general inventive concept will be described with reference to FIGS. 1 and 5.

First, the sound processing apparatus 100 detects the motion of the object 200 in operation S10. For example, the infrared sensor detects the motion of the object 200 and transmits the detection result to the controller 150.

The sound processing apparatus 100 photographs the object 200 and generates the plurality of images in operation S20. As illustrated in FIG. 3, the first and second cameras 111 and 112 may photograph the object 200 simultaneously, and may generate the first and second images 211 and 221, respectively.

The sound processing apparatus 100 recognizes the position of the object 200 with the plurality of generated images 211 and 221. For example, the controller 150 compares the plurality of images 211 and 221 to recognize the position of the object 200, and determines whether the position of the object is out of the range of the sweet spot in operation S30.

The sound processing apparatus 100 adjusts the property of the sound corresponding to the position of the object 200 in operation S40. For example, if the position of the object 200 is out of the range of the sweet spot, the controller 150 adjusts the property of the sound according to a predetermined ratio so that the object 200 is within the sweet spot.

The sound processing apparatus 100 outputs the processed sound in operation S50. For example, the processed sound may be output through the sound output unit 130 like the plurality of speakers.

As described above, the present general inventive concept provides a sound processing apparatus which provides optimal sound according to a user's position, and a sound processing method thereof.

Also, the present general inventive concept provides a sound processing apparatus which recognizes a user's position more accurately with a camera, and a sound processing method thereof.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A sound processing apparatus, comprising:
a sound processor to process sound;
a plurality of image generators to photograph an object and generate an image, respectively; and
a controller to recognize a position of the object using the plurality of images generated by the plurality of image generators, and to control the sound processor to adjust a property of the sound corresponding to the position of the object.

2. The sound processing apparatus according to claim 1, wherein the property of the sound comprises at least one of frequency, waveform, delay time and volume according to frequency band.

3. The sound processing apparatus according to claim 1, wherein the plurality of image generators photographs the object at predetermined time intervals.

4. The sound processing apparatus according to claim 2, wherein the plurality of image generators photographs the object at predetermined time intervals.

5. The sound processing apparatus according to claim 1, further comprising:
a motion detector to detect a motion of the object, wherein
the controller controls the plurality of image generators to photograph the object and generate images if the motion of the object is detected.

6. The sound processing apparatus according to claim 1, further comprising a sound output unit to output sound processed by the sound processor.

7. A sound processing method, comprising:
photographing an object and generating a plurality of images;
recognizing a position of the object using the plurality of generated images; and
adjusting a property of the sound corresponding to the position of the object.

8. The sound processing method according to claim 7, wherein the property of the sound comprises at least one of frequency, waveform, delay time and volume according to a frequency band.

9. The sound processing method according to claim 7, wherein the generating the plurality of images comprises photographing the object at predetermined time intervals.

10. The sound processing method according to claim 8, wherein the generating the plurality of images comprises photographing the object at predetermined time intervals.

11. The sound processing method according to claim 7, wherein the generating of the plurality of images comprises:
photographing the object; and
generating the images if the motion of the object is detected.

12. The sound processing method according to claim 7, further comprising:
adjusting the property of the sound corresponding to a position of the object; and
outputting the processed sound.

13. A sound processing apparatus to process and output sound, the sound processing apparatus comprising:
a sensor to sense a location of an object by generating a plurality of images of the object and by comparing the plurality of generated images; and
a controller to adjust a property of the sound corresponding to the sensed location of the object.

14. The sound processing apparatus of claim 13, wherein the sensor comprises:
a plurality of image generators to generate the plurality of images of the object by photographing the object.

15. The sound processing apparatus of claim 14, wherein the controller compares locations of the object in each of the plurality of images to determine whether a property of the sound should be adjusted.

16. The sound processing apparatus of claim 14, wherein the sensor further comprises:
a motion detector to detect a new location of the object if the object moves, and to send information regarding the object's new location to the controller to adjust a property of the sound corresponding to the new location of the object.

17. The sound processing apparatus of claim 16, wherein the motion detector includes an infrared sensor to sense objects which are above a certain temperature.

18. The sound processing apparatus of claim 13, wherein the sensor comprises:
a plurality of heat-signature reading devices to each detect a heat signature of the object and generate the images based on the heat signatures.

19. A sound processing method, comprising:
generating a plurality of images of an object;
comparing the plurality of generated images in order to determine a location of the object; and
adjusting a property of sound corresponding to the determined location of the object.

20. The sound processing method of claim 18, further comprising:
photographing the object from multiple angles; and
generating corresponding images to denote a location of the object relative to the sensor.

21. The sound processing method of claim 19, further comprising:
detecting a new location of the object if the object moves; and
sending information regarding the object's new location to a controller to adjust a property of the sound corresponding to the new location of the object.

22. The sound processing method of claim 18, further comprising:
detecting a heat signature of the object from multiple angles; and
generating the images based on the heat signatures.
